(19) United States
(12) Patent Application Publication
(10) Pub. No.: US 2023/0409553 A1
(43) Pub. Date: Dec. 21, 2023

(54) HUMAN-IN-THE-LOOP CONFLICT RESOLUTION IN A COLLABORATIVE DATA LABELING PLATFORM

(71) Applicant: INTERNATIONAL BUSINESS MACHINES CORPORATION, ARMONK, NY (US)

(72) Inventors: Michelle Brachman, Quincy, MA (US); Qian Pan, Canton, MA (US); Narendra Nath Joshi, Mountain View, CA (US); Aabhas Sharma, Cambridge, MA (US); Casey Dugan, Cambridge, MA (US)

(21) Appl. No.: 17/807,412

(22) Filed: Jun. 17, 2022

(51) Int. Cl. G06F 16/23; G06F 16/18

(52) U.S. Cl. CPC G06F 16/23; G06F 16/18

(57) ABSTRACT

A method, computer system, and a computer program product for data labeling is provided. The present invention may include receiving a plurality of labeled data points. The present invention may include identifying one or more of the plurality of labeled data points with conflicting labels. The present invention may include determining that at least one of the one or more identified labeled data points exceeds one or more conflict thresholds. The present invention may include presenting the at least one or more identified labeled data points exceeding one or more conflict thresholds to a user. The present invention may include receiving a conflict resolution from the user for the one or more identified labeled data points exceeding the one or more conflict thresholds.

### BACKGROUND

The present invention relates generally to the field of computing, and more particularly to data labeling.

Even with the rise of unsupervised learning and weak supervision techniques, human-labeled data is often still a necessary part of machine learning pipelines for different contexts and/or applications. This branch of artificial intelligence (AI) may be referred to as a human-in-the-loop (HITL) system. A HITL system may leverage both human and machine intelligence in the creation of a machine learning model. This may often involve using humans for the task of labeling large amounts of data which may be an asynchronous process and may lead to conflict amongst labelers, where individual labelers potentially submit labels in disagreement from each other. When noisy data is fed to a machine learning model, the accuracy and/or performance of the overall system may be jeopardized.

One popular workaround may be to entirely discard the data items with conflict. However, this may lead to loss of data points which may be crucial in determining decision boundaries for the model itself. Another possibility may be to automate the conflict resolution which may rely on models to reliably solve problems for which humans may disagree.

### SUMMARY

Embodiments of the present invention disclose a method, computer system, and a computer program product for data labeling. The present invention may include receiving a plurality of labeled data points. The present invention may include identifying one or more of the plurality of labeled data points with conflicting labels. The present invention may include determining that at least one of the one or more identified labeled data points exceeds one or more conflict thresholds. The present invention may include presenting the at least one or more identified labeled data points exceeding one or more conflict thresholds to a user. The present invention may include receiving a conflict resolution from the user for the one or more identified labeled data points exceeding the one or more conflict thresholds.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for data labeling according to at least one embodiment;

FIG. 3 is an exemplary illustration of a training process displayed by the data labeling program 110 in the data labeling user interface 118;

FIG. 4 is an exemplary illustration of a refinement process displayed by the data labeling program 110 in the data labeling user interface 118;

FIG. 5 is an exemplary illustration of a conflict resolution process displayed by the data labeling program 110 in the data labeling user interface 118;

FIG. 6 is a block diagram of internal and external components of computers and servers depicted in FIG. 1 according to at least one embodiment;

FIG. 7 is a block diagram of an illustrative cloud computing environment including the computer system depicted in FIG. 1, in accordance with an embodiment of the present disclosure; and

FIG. 8 is a block diagram of functional layers of the illustrative cloud computing environment of FIG. 7, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for data labeling. As such, the present embodiment has the capacity to improve the technical field of data labeling by leveraging a HITL system in enabling automated and/or manual resolution of conflicting data labels. More specifically, the present invention may include receiving a plurality of labeled data points. The present invention may include identifying one or more of the plurality of labeled data points with conflicting labels. The present invention may include determining that at least one of the one or more identified labeled data points exceeds one or more conflict thresholds. The present invention may include presenting the at least one or more identified labeled data points exceeding one or more conflict thresholds to a user. The present invention may include receiving a conflict resolution from the user for the one or more identified labeled data points exceeding the one or more conflict thresholds, wherein the conflict resolution selected by the user is utilized in training a machine learning model.

As described previously, even with the rise of unsupervised learning and weak supervision techniques, human labeled data is often still a necessary part of machine learning pipelines for different contexts and/or applications. This branch of artificial intelligence (AI) may be referred to as a Human-in-the-loop (HITL) system. A HITL system may leverage both human and machine intelligence in the creation of a machine learning model. This may often involve using humans for the task of labeling large amounts of data which may be an asynchronous process and may lead to conflict amongst labelers, where individual labelers potentially submit labels in disagreement from each other. When noisy data is fed to a machine learning model, the accuracy and/or performance of the overall system may be jeopardized.

One popular workaround may be to entirely discard the data items with conflict. However, this may lead to loss of data points which may be crucial in determining decision boundaries for the model itself. Another possibility may be to automate the conflict resolution which may rely on models to reliably solve problems for which humans may disagree.

Therefore, it may be advantageous to, among other things, receive a plurality of labeled data points, identify one or more labeled data points within the plurality of labeled data points with conflicting labels, determine if the one or more labeled data points with the conflicting labels exceeds one or more conflict thresholds, and presenting the one or more labeled data points with the conflicting labels exceeding the one or more conflict thresholds to a user.

According to at least one embodiment, the present invention may improve conflicting data labels by enabling a user (e.g., moderator) to resolve labeled data points with conflicting labels either automatically and/or manually based on one or more conflict thresholds. This approach may improve the resolution of conflicting data labels by both leveraging an expertise of the user (e.g., moderator) and/or automating conflicting labels within and/or below certain conflict thresholds.

According to at least one embodiment, the present invention may improve the efficiency by which annotations and/or labels assigned to a plurality of labeled data points may be resolved by enabling the user (e.g., moderator) to set one or more conflict thresholds within a data labeling user interface 118 which may enable the user (e.g., moderator) to manually resolve conflicting data labels which may be the most important in the creation and/or training of a machine learning model.

According to at least one embodiment, the present invention may improve support provided to a user (e.g., moderator) of a data labeling system by providing support in a data labeling user interface 118 which may enable the user (e.g., moderator) to automatically resolve conflicting data labels utilizing machine learning model predictions and/or manually based on at least the context, data, data labeler profiles, amongst other information.

According to at least one embodiment, the present invention may improve workload management for the user (e.g., moderator) of a data labeling system by only presenting the one or more labeled data points with the conflicting labels exceeding the one or more conflict thresholds to the user (e.g., moderator). The data labeling program may automatically adjust each of the one or more conflict thresholds over time and/or provide a prompt to the user (e.g., moderator) in the data labeling user interface allowing the user (e.g., moderator) to accept or deny the new conflict thresholds and/or actively manage the conflicting data labels presented to the user (e.g., moderator).

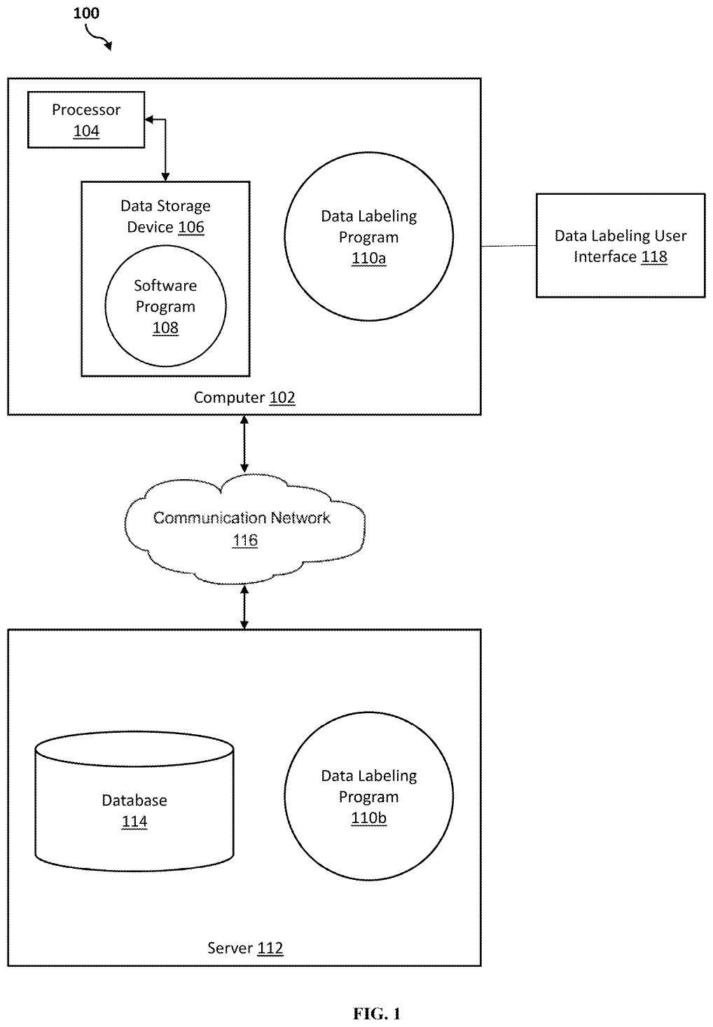

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a data labeling program 110a. The networked computer environment 100 may also include a server 112 that is enabled to run a data labeling program 110b that may interact with a database 114 and a communication network 116. The networked computer environment 100 may include a plurality of computers 102 and servers 112, only one of which is shown. The networked computer environment 100 may also include a data labeling user interface 118. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

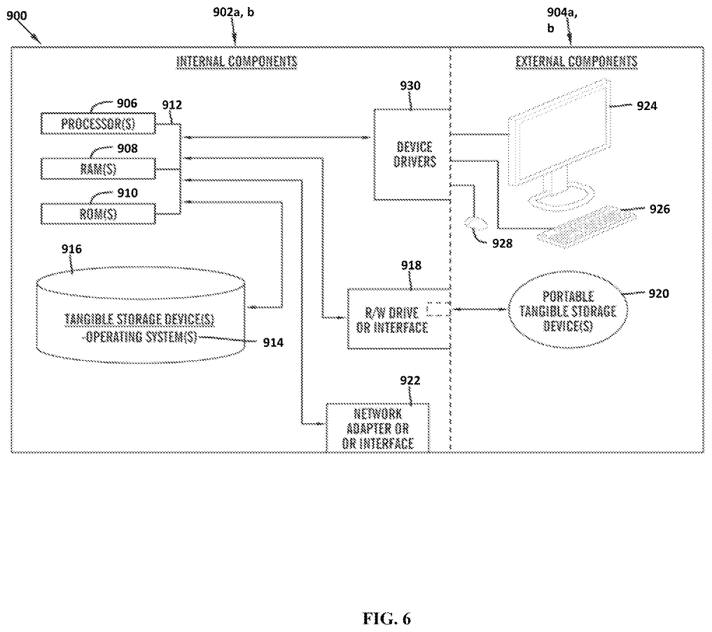

The client computer 102 may communicate with the server computer 112 via the communications network 116. The communications network 116 may include connections, such as wire, wireless communication links, or fiber optic cables. As will be discussed with reference to FIG. 6, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the data labeling program 110a, 110b may interact with a database 114 that may be embedded in various storage devices, such as, but not limited to a computer/mobile device 102, a networked server 112, or a cloud storage service.

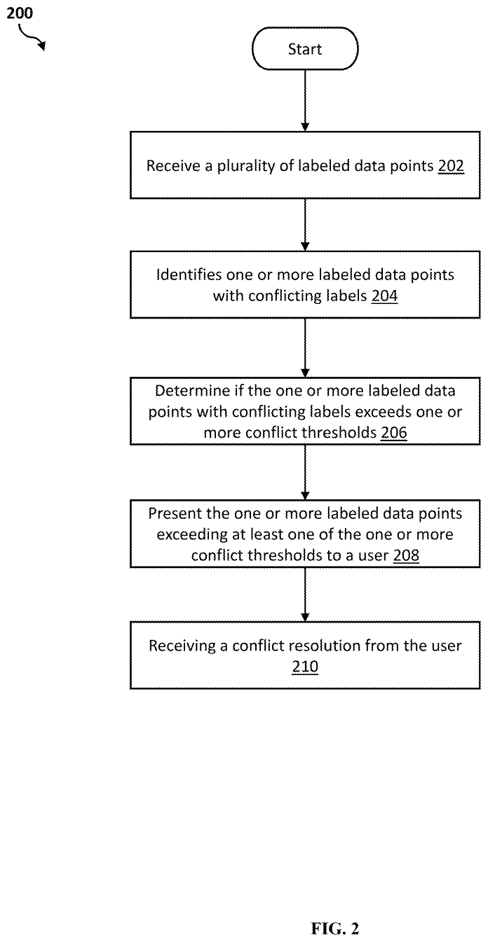

According to the present embodiment, a user using a client computer 102 or a server computer 112 may use the data labeling program 110a, 110b (respectively) to efficiently resolve data points with conflicting labels. The data labeling method is explained in more detail below with respect to FIGS. 2 through 5.

Referring now to FIG. 2, an operational flowchart illustrating the exemplary data labeling process 200 used by the data labeling program 110a and 110b according to at least one embodiment is depicted.

At 202, the data labeling program 110 receives a plurality of labeled data points. Data labeling may be the process by which raw data, such as, but not limited to, images, text files, audio files, videos, amongst other raw data may be identified using one or more meaningful and/or informative labels. The meaningful and/or informative labels may provide context to the raw data which may enable a machine learning model to learn from the labeled data points.

The data labeling program 110 may receive the plurality of labeled data points in a data labeling user interface 118. The data labeling user interface 118 may be displayed by the data labeling program 110 in at least an internet browser, dedicated software application, and/or as an integration with a third party software application. The plurality of labeled data points received by the data labeling program 110 may be labeled directly by a plurality of data labelers within the data labeling user interface 118 and/or received from a third party source.

The data labeling program 110 may provide annotation tools such as, but not limited to, image annotation tools, text annotation tools, audio annotation tools, amongst other annotation tools to the plurality of data labelers within the data labeling user interface 118. The data labeling program 110 may also enable a user to provide a label set for a given data set in which the plurality of data labelers may select from in labeling the plurality of data points. Each of the plurality of data labelers may have a data labeler profile, the data labeler profile may include information such as, but not limited to, areas of expertise, number of data points labeled, data labeling reliability details, amongst other information which may be added by the data labeler and/or data which may be monitored by the data labeling program 110 and stored in a knowledge corpus (e.g., database 114).

As will be explained in more detail below with respect to at least steps 206 and 208, the data labeling reliability details may be determined based on at least a frequency by which a user (e.g., moderator) reverses the label assigned to a data point by one of the plurality of data labelers. As will be explained in further detail below, the data labeling reliability details may also be utilized by the data labeling program 110 in at least determining whether the one or more labeled data points with conflicting labels exceeds a conflict threshold, presenting the one or more data points with conflict labels exceeding the conflict threshold to a user (e.g., moderator), and/or identifying one or more of the plurality of data labelers as a potential user (e.g., moderator).

At 204, the data labeling program 110 identifies one or more of the plurality of labeled data points with conflicting labels. The one or more labeled data points with conflicting labels may be data points in which at least two or more of the plurality of data labelers assigned different labels to the one or more labeled data points.

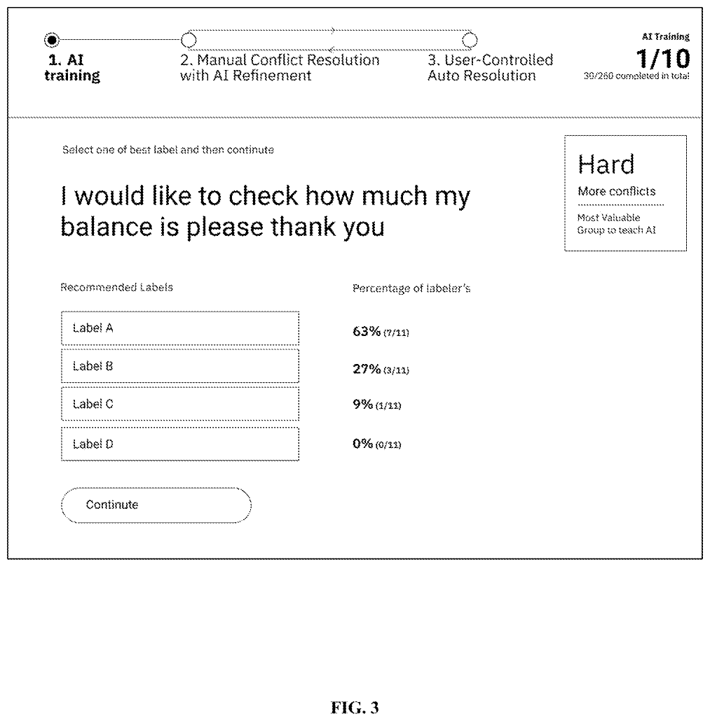

The data labeling program 110 may identify the one or more labeled data points with conflicting labels labeled in the data labeling user interface 118 by utilizing a plurality of recommended labels. As will be explained in more detail below with respect to at least FIG. 3, the plurality of labeled data points with their corresponding labels may be displayed to the user (e.g., moderator) within the data labeling user interface 118 based on the labels assigned by the plurality of data labelers at step 202 and/or the plurality of labeled data points received from the third party source at step 202. In an embodiment in which the plurality of data points received by the data labeling program 110 may be labeled directly by the plurality of data labelers within the data labeling user interface 118 the data labeling program 110 may identify the one or more labeled data points with conflicting labels based on the number of labels which agree and/or differ. A training phase will be described in more detail below with respect to FIG. 3 and may be utilized by the data labeling program 110 in training a machine learning model. The machine learning model may be an active learning and/or online learning type model, in which the model may be trained incrementally by the data labeling program 110 as the user (e.g., moderator) manually resolves conflicting labels of one or more labeled data points. As will be described in more detail below, the machine learning model may be utilized by the data labeling program 110 in at least ordering tasks for the user (e.g., moderator) and/or automatically resolving tasks for the user (e.g., moderator) based at least in part on one or more conflict thresholds.

In an embodiment, the plurality of labeled data points received by the data labeling program 110 may be received from a third party source. In this embodiment, the data labeling program 110 may utilize one or more linguistic analysis techniques and/or a classification machine learning model in identifying the one or more labeled data points with conflicting labels. The one or more linguistic analysis techniques may include, but are not limited to including, a machine learning model with Natural Language Processing (NLP), Semantic Textual Similarity (STS), Keyword Extraction, amongst other analysis techniques, such as those implemented in IBM Watson® (IBM Watson and all Watson-based trademarks are trader registered trademarks of International Business Machines Corporation in the United States, and/or other countries), IBM Watson® Natural Language Understanding, IBM Watson® Natural Language Classifier, amongst other implementations. The classification machine learning model utilized by the data labeling program 110 may utilize the one or more linguistic analysis techniques in classifying each of the one or more labels assigned to the labeled data points. The classification machine learning model may be a multi-class classification model. The multi-class classification model may utilize one or more machine learning algorithms, such as, but not limited to, k-Nearest Neighbors, Decision Trees, Naïve Bayes, Random Forest, Gradient boosting, amongst other machine learning algorithms in classifying each of the one or more labels assigned to the labeled data points.

At 206, the data labeling program 110 determines if the one or more labeled data points with conflicting labels exceeds one or more conflict thresholds. The one or more conflict thresholds may be a predetermined value and/or set by the user (e.g., moderator) within the data labeling user interface 118.

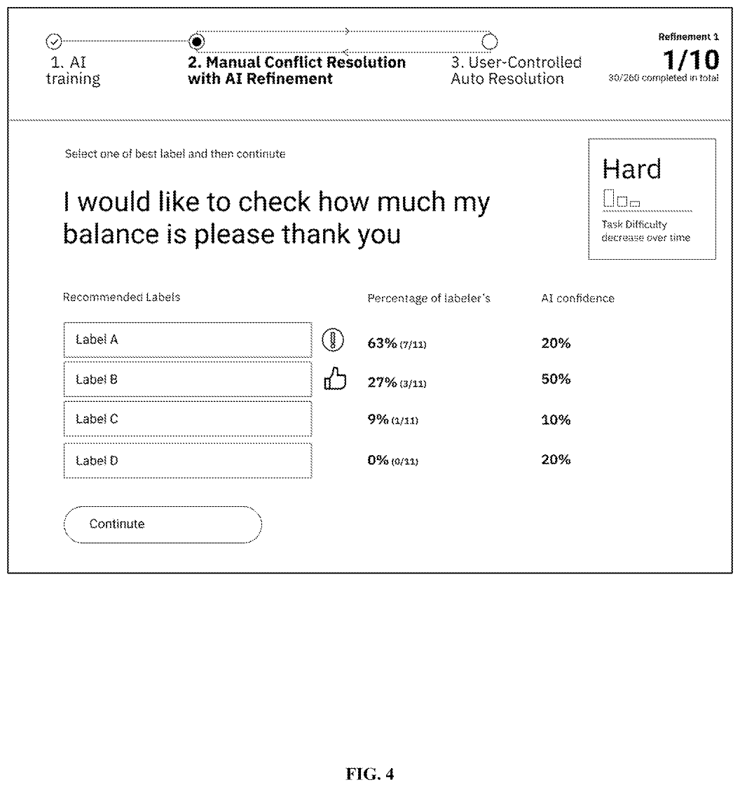

As will be described in more detail below with respect to FIG. 4 a refinement phase may be utilized by the data labeling program 110. In the refinement phase the user (e.g., moderator) may manually resolve the one or more labeled data points with conflicting labels for all of the one or more conflict thresholds. The refinement phase may be utilized to further train the machine learning model and enable the user (e.g., moderator) to access the machine learning models predictions for resolving the conflicting labels. As will be described in more detail below, the machine learning model predictions and/or an associated confidence score for each prediction may be displayed by the data labeling program 110 to the user (e.g., moderator) in the data labeling user interface 118.

Each of the one or more conflict thresholds may be a predetermined value and/or set by the user (e.g., moderator) within the data labeling user interface 118. As will be explained in more detail below, the one or more conflict thresholds may be adjusted over time based on the training and refining of the machine learning model. The data labeling program 110 may adjust each of the one or more conflict thresholds automatically over time as the machine learning model is trained and/or refined and/or the data labeling program 110 may provide a prompt to the user (e.g., moderator) within the data labeling user interface 118 with one or more new recommended conflict thresholds which the user (e.g., moderator) may accept, deny, and/or modify. The one or more conflict thresholds may be based on thresholds of data labeler agreement and/or an Artificial Intelligence (AI) confidence metric of the machine learning model. As will be explained in more detail below, the user (e.g., moderator) may enable the data labeling program 110 to auto resolve conflicting data labels within the one or more conflict thresholds utilizing the machine learning model.

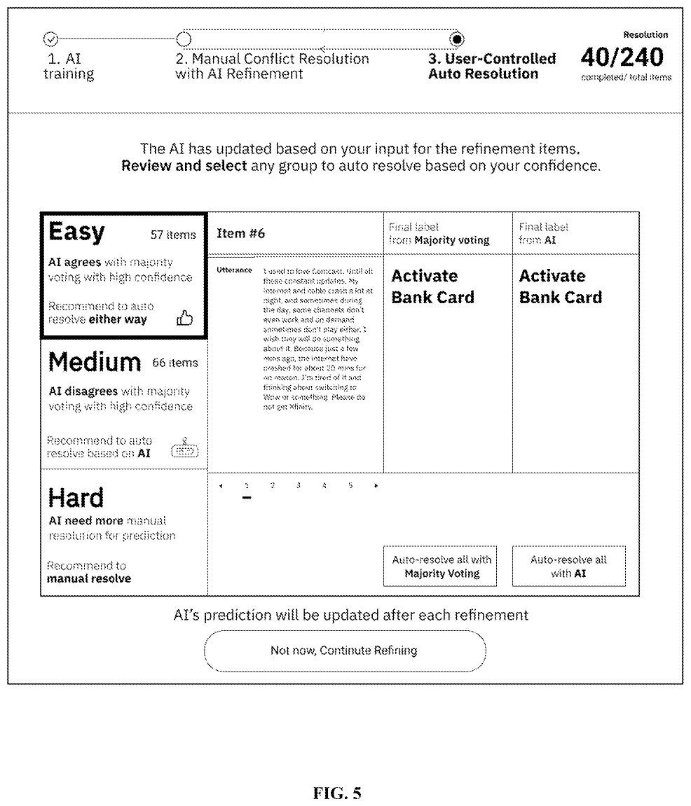

The one or more conflict thresholds may be split into one or more conflict categories, such as, but not limited to, easy, medium, or hard, depending on the conflict threshold. The one or more conflict thresholds may be a number, percentage, and/or other value of conflicting labels and/or a number, percentage, and/or other value representing the AI confidence metric of the machine learning model. As will be explained in more detail below, the data labeling program 110 may also utilize the data labeler profile stored in the knowledge corpus (e.g., database 114) associated with each of the plurality of data labelers which may have labeled the one or more labeled data points with conflicting labels in determining which of the one or more labeled data points may be presented to the user (e.g., moderator). For example, the data labeling program 110 may utilize 3 different conflict categories. Category 1 may be an Easy Conflict Category, for the Easy Conflict Category the conflict threshold may be 95%. The 95% may represent the number of labeled data points with the same label with the 5% remaining being one or more conflicting labels. Category 2 may be a Medium Conflict Category, for the Medium Conflict Category the conflict threshold may be 80%. The 80% may represent the number of labeled data points with the same label with the 20% remaining being one or more conflicting labels. Category 3 may be a Hard Conflict Category, for the Hard Conflict Category the conflict threshold may be 60%. The 60% may represent the number of labeled data points with the same label with the 40% remaining being one or more conflicting labels. In this example, the user (e.g., moderator) may resolve the conflicting data labels for all 3 different conflict categories in both the training phase and the refinement phase of the machine learning model. As described in FIG. 4, in the refinement phase the user (e.g., moderator) may have access to the machine learning model's prediction for conflict resolution in the form of the AI confidence metric. As will be explained in more detail below with respect to FIG. 5 in the conflict resolution phase the user (e.g., moderator) may enable the data labeling program 110 to auto resolve one or more labeled data points with conflicting labels for at least one of the one or more conflict categories utilizing the machine learning model.

In an embodiment, the data labeling program 110 may also utilize the information included in each of the plurality of data labeler profiles in determining if the one or more labeled data points with conflicting labels exceeds the one or more conflict thresholds. For example, a labeled data point may include 100 labels, 85 of which may be Label A, 10 of which may be Label B, and 5 of which may be label C. The data labeling program 110 may access the information included in each of the 100 data labeler profiles from the knowledge corpus (e.g., database 114). The data labeling program 110 may leverage for example, the areas of expertise, number of data points labeled, data labeling reliability details, amongst other information which may be stored in the knowledge corpus (e.g., database 114). In this example, the data labeler profiles which assigned Label A may include 65 data labelers with expertise relating to the subject of the labeled data point, more experience in labeling data points, and/or higher data reliability details than the data labelers which assigned Label B and/or Label C. In this example the machine learning model may leverage the data labeler profiles in generating the AI confidence metric which may enable the user (e.g., moderator) to make a more informed decision in resolving the conflicting data points which will be described in more detail below with respect to at least step 208 and FIG. 5.

At 208, the data labeling program 110 presents the one or more labeled data points with conflicting labels exceeding the one or more conflict thresholds to a user. The data labeling program 110 may present the one or more labeled data points with conflicting labels exceeding the one or more conflict thresholds to the user (e.g., moderator) in the data labeling user interface 118. The data labeling program 110 may provide the user (e.g., moderator) with the one or more labeled data points with conflicting labels, a percentage of the plurality of data labelers who assigned those labels, and/or the predicted labels of the machine learning model as well as the AI confidence metric in the data labeling user interface 118.

As will be explained in more detail below in FIG. 5, the user (e.g., moderator) may review the conflicting labels for the one or more labeled data points and select an appropriate data label for each of the one or more data points in the data labeling user interface 118. The one or more labeled data points with conflicting labels may be grouped in the data labeling user interface 118 according to at least the one or more conflict categories. The data labeling program 110 may recommend to the user (e.g., moderator) how to resolve the conflict resolution for each conflict category with a recommended resolution method. For example, the data labeling program 110 may recommend the user (e.g., moderator) resolve the Easy Conflict Category using either Majority Voting and/or Auto-Resolve with Artificial Intelligence (AI), resolve the Medium Conflict Category using Auto-Resolve with AI, and resolve the Hard Conflict Category manually. In this example, the Majority Voting may resolve the one or more conflicting data labels according to the label assigned by the greatest percentage of the plurality of data labelers. In this example, the Auto-Resolve with AI may resolve the one or more conflicting data labels according to the greatest AI confidence metric, wherein the AI confidence metric may be based on at least the conflicting labels resolved by the user (e.g., moderator) during the training and/or refinement phase described in detail above.

At 210, the data labeling program 110 receives a conflict resolution from the user (e.g., moderator). The data labeling program 110 may receive the conflict resolution from the user (e.g., moderator) in the data labeling user interface 118. The conflict resolution from the user (e.g., moderator) may be auto resolved utilizing at least Majority Voting and/or Auto-Resolve with AI and/or manually resolved by the user (e.g., moderator). The data labeling program 110 may continue to train and/or refine the machine learning model based on at least the conflict resolutions from the user (e.g., moderator) which may be manually resolved.

In an embodiment, the data labeling program 110 may also utilize the conflict resolution received from the user (e.g., moderator) in updating the information in each data labeler profile which may be utilized in continuing to train and/or refine the machine learning model.

FIG. 3 is an exemplary illustration of a training phase displayed by the data labeling program 110 in the data labeling user interface 118. FIG. 3 illustrates a plurality of data points with their corresponding labels which may be received at step 202. The labels depicted are Label A, Label B, Label C, and Label D, with the corresponding percentage of data labeler's being 63%, 27%, 9%, and 0%. These labels and the corresponding percentages may be presented to the user (e.g., moderator). The user (e.g., moderator) may manually resolve the conflict and the response may be utilized in training the machine learning model. The machine learning model may be an active learning and/or online learning type model, in which the model may be trained incrementally by the data labeling program 110 as the user (e.g., moderator) manually resolves conflicting labels of one or more labeled data points. In the training phase the user (e.g., moderator) may not be presented with an AI confidence metric, the AI confidence metric will be described in more detail below with respect to FIG. 4.

FIG. 4 is an exemplary illustration of a refinement phase displayed by the data labeling program 110 in the data labeling user interface 118. In the refinement phase the user (e.g., moderator) may still manually resolve the one or more data points with conflicting labels. In the refinement phase the user (e.g., moderator) may be presented with an AI confidence metric, the AI confidence metric may be a predicted conflict resolution by a machine learning model trained based on at least previous conflict resolutions by the user (e.g., moderator) as described in more detail above.

In FIG. 4 the labels depicted are Label A, Label B, Label C, and Label D, with the corresponding percentage of data labeler's being 63%, 27%, 9%, and 0%, and the corresponding AI confidence metric generated by the machine learning model being 20%, 50%, 10%, and 20%. As depicted in FIG. 4, in the refinement phase the user (e.g., moderator) may have access to the machine learning model's prediction with respect to conflict resolution of the labeled data point with conflicting labels when resolving the conflict manually. The AI confidence metric may be based on the machine learning model's training as the user (e.g., moderator) resolves conflicting data labels. As illustrated, the AI confidence metric may not correspond to the labels selected by the plurality of data labelers.

FIG. 5 is an exemplary illustration a conflict resolution phase (e.g., user controlled automated conflict resolution process) displayed by the data labeling program 110 in the data labeling user interface 118. In the conflict resolution phase (e.g., user controlled automated conflict resolution process) the user (e.g., moderator) has an opportunity to benchmark conflict resolution by reviewing the information provided by the data labeling program 110 with respect to the one or more conflict categories.

In FIG. 5 the conflict categories displayed to the user include an Easy Conflict Category, a Medium Conflict Category, and a Hard Conflict Category. In FIG. 5 the data labeling program 110 is recommending to the user (e.g., moderator) that the Easy Conflict Category may be auto resolved using either Majority Voting and/or Auto-Resolve with AI, the Medium Conflict Category should be resolved using Auto-Resolve with AI, and the Hard Conflict Category should be resolved manually. The recommended resolution method may be provided to the user (e.g., moderator) in the data labeling user interface 118 for each of the one or more conflict categories.

It may be appreciated that FIGS. 2 through 5 provide only an illustration of one embodiment and do not imply any limitations with regard to how different embodiments may be implemented. Many modifications to the depicted embodiment(s) may be made based on design and implementation requirements.

FIG. 6 is a block diagram 900 of internal and external components of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 6. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the data labeling program 110a in client computer 102, and the data labeling program 110b in network server 112, may be stored on one or more computer-readable tangible storage devices 916 for execution by one or more processors 906 via one or more RAMs 908 (which typically include cache memory). In the embodiment illustrated in FIG. 6, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the data labeling program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the data labeling program 110a in client computer 102 and the data labeling program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the data labeling program 110a in client computer 102 and the data labeling program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

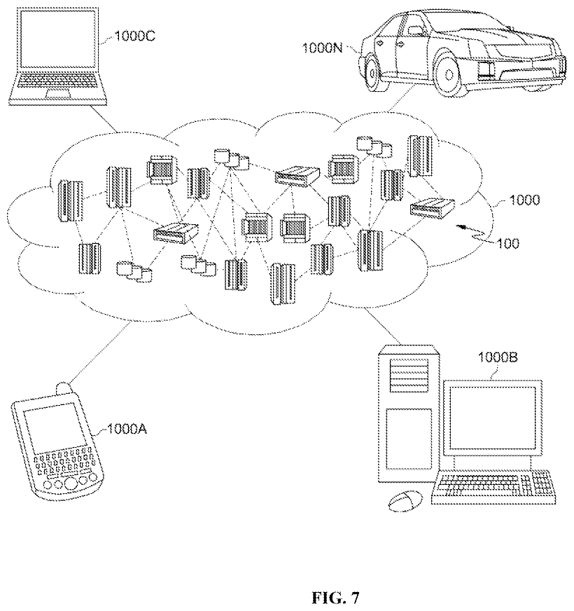

Referring now to FIG. 7, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 7 are intended to be illustrative only and that computing nodes 100 and cloud computing environment 1000 can communicate with any type of computerized device over any type of network and/or network addressable connection (e.g., using a web browser).

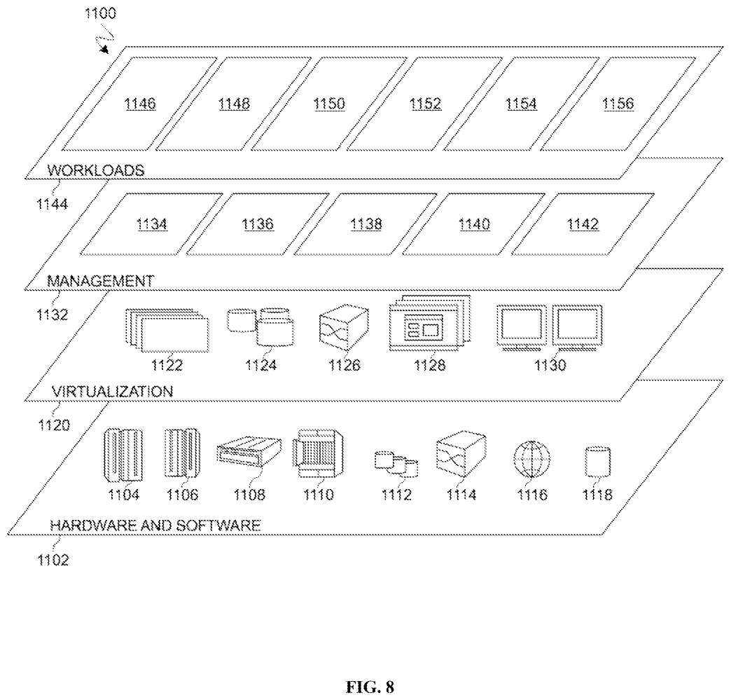

Referring now to FIG. 8, a set of functional abstraction layers 1100 provided by cloud computing environment 1000 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and data labeling program 1156. A data labeling program 110a, 110b provides a way to efficiently resolve data points with conflicting labels.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for data labeling, the method comprising:
receiving a plurality of labeled data points;
identifying one or more of the plurality of labeled data points with conflicting labels;
determining that at least one of the one or more identified labeled data points exceeds one or more conflict thresholds;
presenting the at least one of the one or more identified labeled data points exceeding the one or more conflict thresholds to a user; and
receiving a conflict resolution from the user for the one or more identified labeled data points exceeding the one or more conflict thresholds, wherein the conflict resolution received from the user is utilized in training a machine learning model.

2. The method of claim 1, wherein the conflict resolution is manually selected by the user in a data labeling user interface.

3. The method of claim 1, wherein the one or more conflict thresholds may each be a predetermined value set by the user in the data labeling user interface.

4. The method of claim 3, wherein the one or more conflict thresholds are incrementally adjusted over time based on training and refining of the machine learning model.

5. The method of claim 1, wherein the one or more identified labeled data points exceeding the one or more conflict thresholds are presented to the user in one or more conflict categories.

6. The method of claim 5, wherein each of the one or more conflict categories includes at least one recommended resolution method.

7. The method of claim 6, wherein the at least one recommended resolution method is selected from a group consisting of Majority Voting, Auto-Resolve with Artificial Intelligence, and Manual Resolve.

8. A computer system for data labeling, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a plurality of labeled data points;
identifying one or more of the plurality of labeled data points with conflicting labels;
determining that at least one of the one or more identified labeled data points exceeds one or more conflict thresholds;
presenting the at least one of the one or more identified labeled data points exceeding the one or more conflict thresholds to a user; and
receiving a conflict resolution from the user for the one or more identified labeled data points exceeding the one or more conflict thresholds, wherein the conflict resolution received from the user is utilized in training a machine learning model.

9. The computer system of claim 8, wherein the conflict resolution is manually selected by the user in a data labeling user interface.

10. The computer system of claim 8, wherein the one or more conflict thresholds may each be a predetermined value set by the user in the data labeling user interface.

11. The computer system of claim 10, wherein the one or more conflict thresholds are incrementally adjusted over time based on training and refining of the machine learning model.

12. The computer system of claim 8, wherein the one or more identified labeled data points exceeding the one or more conflict thresholds are presented to the user in one or more conflict categories.

13. The computer system of claim 12, wherein each of the one or more conflict categories includes at least one recommended resolution method.

14. The computer system of claim 13, wherein the at least one recommended resolution method is selected from a group consisting of Majority Voting, Auto-Resolve with Artificial Intelligence, and Manual Resolve.

15. A computer program product for data labeling, comprising:
one or more non-transitory computer-readable storage media and program instructions stored on at least one of the one or more tangible storage media, the program instructions executable by a processor to cause the processor to perform a method comprising:
receiving a plurality of labeled data points;
identifying one or more of the plurality of labeled data points with conflicting labels;
determining that at least one of the one or more identified labeled data points exceeds one or more conflict thresholds;
presenting the at least one of the one or more identified labeled data points exceeding the one or more conflict thresholds to a user; and
receiving a conflict resolution from the user for the one or more identified labeled data points exceeding the one or more conflict thresholds, wherein the conflict resolution received from the user is utilized in training a machine learning model.

16. The computer program product of claim 15, wherein the conflict resolution is manually selected by the user in a data labeling user interface.

17. The computer program product of claim 15, wherein the one or more conflict thresholds may each be a predetermined value set by the user in the data labeling user interface.

18. The computer program product of claim 17, wherein the one or more conflict thresholds are incrementally adjusted over time based on training and refining of the machine learning model.

19. The computer program product of claim 15, wherein the one or more identified labeled data points exceeding the one or more conflict thresholds are presented to the user in one or more conflict categories.

20. The computer program product of claim 19, wherein each of the one or more conflict categories includes at least one recommended resolution method.
